(19) United States
(12) Patent Application Publication
(10) Pub. No.: US 2009/0048872 A1
(43) Pub. Date: Feb. 19, 2009

(54) Mental health expert system and method

(76) Inventors: Joe Toy, Lexington, KY (US); Shannon Ware, Lexington, KY (US); Art Shechet, Lexington, KY (US); Vu Nguyen, Lexington, KY (US); Corey Cecll, Lexington, KY (US)

Correspondence Address: STOCKWELL & SMEDLEY, PSC, 861 CORPORATE DRIVE, SUITE 200, LEXINGTON, KY, 40503, US

(21) Appl. No.: 11/893,658

(22) Filed: Aug. 17, 2007

(51) Int. Cl. G06Q 50/00

(52) U.S. Cl. 705/3

(57) ABSTRACT

An electronic solution which may be integrated into an existing patient database and billing system to provide risk assessments, clinical prompts, and treatment pathways in a behavioral healthcare environment. Furthermore, consultation and review features are provided to ensure leadership oversight and authorization of any activity.

### BACKGROUND OF THE INVENTION

1. Field of the Invention

The present invention relates generally to a computer software application and, more particularly, to electronic medical reports.

2. Description of Related Art

Providing behavioral healthcare services typically includes generating a lot of paper to document various health and risk assessments and treatment pathways. The information on these various papers is sometimes redundant but such redundancy cannot be utilized to streamline data collection because of the physical nature of paper records. Also, the quick accessing and correlating of such information is hindered as well by the records being on paper. Furthermore, while a service provider may have experience or a checklist to help them with an assessment or diagnosis, people are fallible and important steps or information in the processes may be overlooked.

Accordingly, there remains a need in the art for a paperless documentation system for the behavioral healthcare environment which guides a user through a process of automatically collecting and documenting data necessary to perform services for a patient.

### BRIEF SUMMARY OF THE INVENTION

Embodiments of the present invention relate to an electronic solution which may be integrated into an existing patient database and billing systems to provide risk assessments, clinical prompts, and treatment pathways in a behavioral healthcare environment. Furthermore, consultation and review features are provided to ensure leadership oversight and authorization of any activity.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

Various aspects of a medical computer system are illustrated by way of example, and not by way of limitation, in the accompanying drawings, wherein:

FIGS. 1-16 depict exemplary screen shots of a system operating according to the principles of the present invention.

### DETAILED DESCRIPTION OF INVENTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

A software application is described herein that is an innovative solution for paperless documentation in either a single or multiple provider/multiple location practice specializing in behavioral healthcare, including substance abuse. The application includes clinical protocols and algorithms that have been successfully proven and refined in a professional care environment by multiple practitioners. Of particular note are the integrated risk assessments, clinical prompts and treatment pathways, and consultation and review features to ensure senior leadership oversight and appropriate authorization. The software is an electronic solution suitable for the most comprehensive systems of care and can be integrated into existing patient database, billing, human resource, or other enterprise systems.

Among the many features that are designed to maximize user ease and efficiency are: the multiple data entry modes built into the screen design (keyboard, voice, handwriting via tablet); one click access to comprehensive patient summary reports; internal messaging; quick links to billing, pharmacy orders, laboratory orders and results; documentation guides; group encounters; and compliance tracking for due dates, authorizations, billing protocols, risk alerts, and other reminders.

The software's architecture is intended as a server based application with end users equipped with a personal desktop solution and customized options, real time updates, and server/system supported storage and back up. The server also supports the access and retrieval of overall client database integration, clinical tables, HIPPA compliant security features, and all exchange data capabilities to maintain updates between application and the organization's other information technology infrastructure.

Specific features included in embodiments of the present invention can include the following items:

Clinical Practice Protocols/Algorithms/Pathways

Treatment Planning—with Progress Ratings

Rehabilitation Planning

Substance Abuse Assessment

Risk Assessments (also included inside Progress Notes)

Internal Messaging—Clinical Consults/Reviews

Second Signatures (credentials)

Risk Management

Input from Mentors, supervisors, etc.

Server Architecture: Fitting the software to the Organization's overall IT

### Management Structure

Uses existing tables: Employee and Client Databases

Billing Rules—functional prompts, security, HIPPA compliant

Real-time updates to Servers via an exchange architecture

Plugs into other Proprietary software systems (Lab, Prescription, Toolbox)

Group Services/Encounters

Scheduling

Tracking

Rosters

Mobile Capabilities for Electronic Charting

Tablet-based handwriting recognition, keyboarding, and voice capabilities

Authorizations:

Client Acknowledgments/Signatures/Compliance

Clinical Forms and Prompts/Data Dictionaries: Increasing the speed/efficiency of electronic documentation

Reminders for Staffing Due; Treatment Plan Ratings Due; Risk Alerts

Custom clinician-generated pick lists for clinical assessments

Helpful prompts for compliance, reminders

Quick Review Reports

Chart Summary

Treatment Plan Report

Substance Abuse Assessment

Rehabilitation Plan

Diagnostic Review/History

The software application features that are described briefly above are described in more detail below by discussing a variety of screen shots that would be presented to a user of the system. It is to be understood that the exemplary screenshots are included to disclose the types of different content and data that is useful to a user of the system and also useful for the system to operate efficiently. The present invention is not limited to the specific format shown in the exemplary screen shots nor is it limited to only the data and content revealed in the figures. Also, one of ordinary skill will readily recognize that the underlying computer system (hardware and software), database system, computer-readable storage, and networking facilities may vary without departing from the scope of the present invention.

Electronic Medical Records

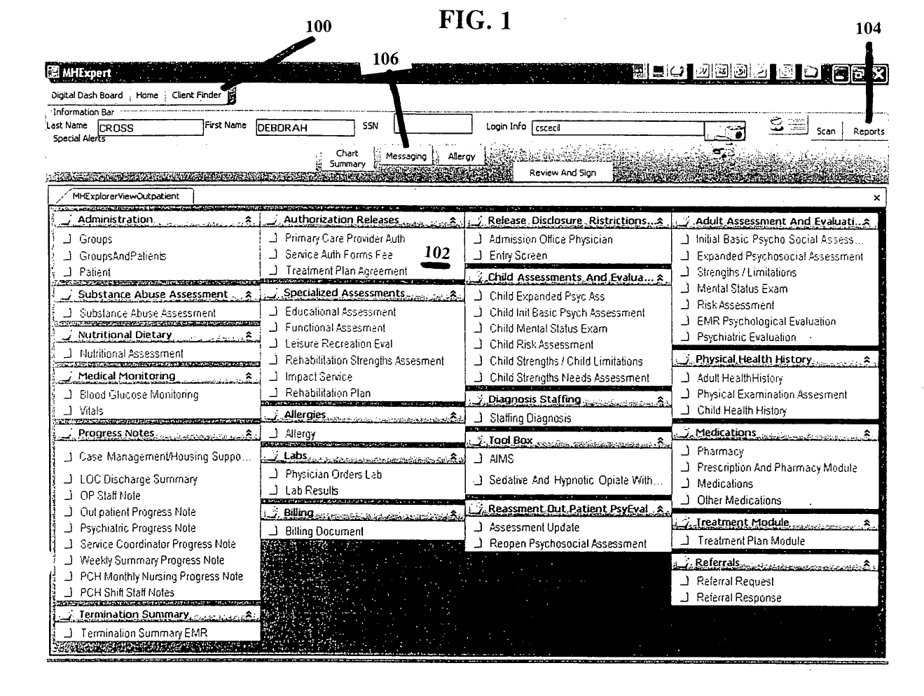

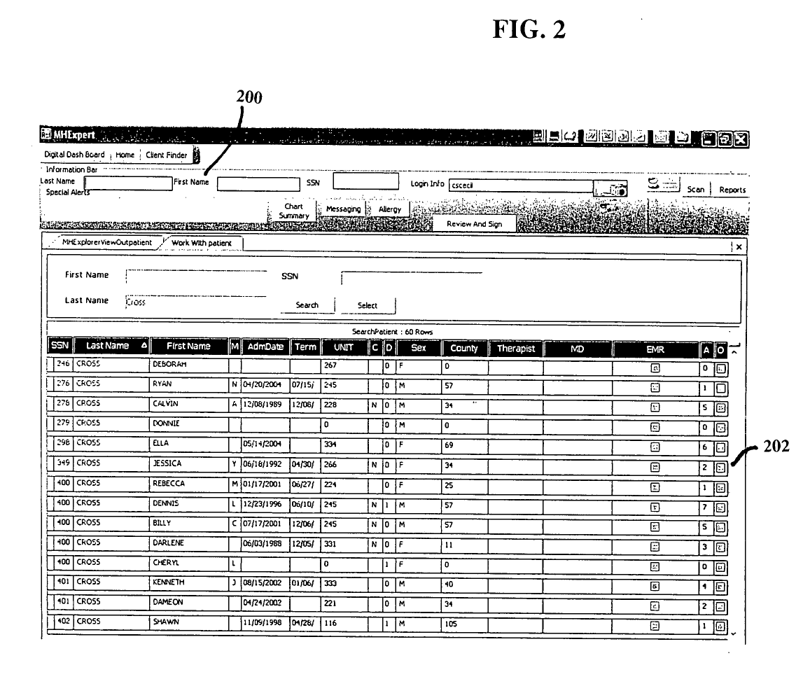

FIG. 1 depicts an opening screen that welcomes a user to the system. From this screen a user may choose from among many different options provided by the present system. In the region 102 of the welcome screen, the user may, for example, choose to look at health histories, perform assessments, provide administrative data, interface with labs, and many more features. The many different menu options are shown in order to disclose how integrated the present system is with all aspects of providing patient services. The client finder button 100 may be used to select the patient who is the subject of the user's current interaction with the system. For example, selecting that button will open a window (See FIG. 2) that allows a patient to be selected so that the other options in region 102 would then be appropriate. There are other options shown on FIG. 1 such as “Reports” 104 and “Messaging” 106 that will be discussed in more detail herein.

In FIG. 2, a patient can be searched for by typing in a name or social security number in region 200. The results of the search are shown in the list region 202 and a particular patient can then be selected. According to one embodiment of the present invention, any searches may be logged for security audits and a user may be asked to enter the reason for the search before allowing them access to a patient's record. Once a patient is selected, then the user is returned to the main screen shown in FIG. 1. From here, a user can create and edit data in the patient's electronic medical record. In this manner, access to certain information may be restricted (e.g., HIPPA compliance) and the activities of users may be monitored and tracked.

One of the first tasks accomplished with a patient is the performance of a variety of assessments. Unlike previous systems where the assessor would have to write, type or record (for later transcription) the assessment, the present system captures the assessments through a series of pick lists. These pick lists are pre-populated with the most likely and most necessary items for each assessment. The user may then simply select from among the pick lists to create and generate an assessment.

Assessments can include Nutritional, Educational, Functional, Recreation, Impact Service, Child (Adult) Mental Status Exam, Child (Adult) Risk Assessment, Child (Adult) Strengths/Limitations, Child (Adult) Needs Assessment, Assessment Update, Rehabilitation, Child (Adult) Psychosocial Assessment (Basic and Expanded), Psychiatric Evaluation, Psychological Evaluation, Terminations Summary, AIMS, Sedative and Hypnotic Withdrawal Assessment, Substance Abuse Assessment, and Physical Exam.

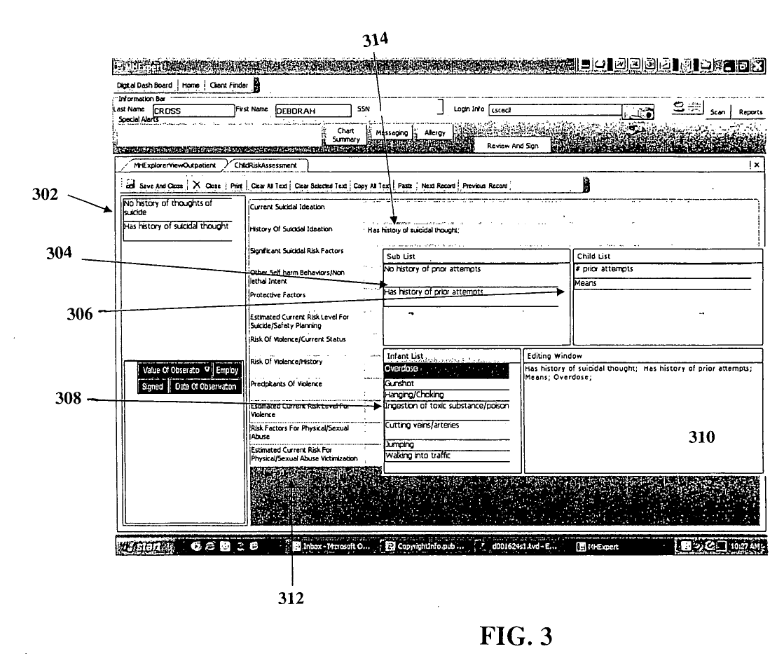

For example, FIG. 3 shows a Child Risk Assessment Screen. The main pick list 302 is shown in the left pane of the screen and the sub pick lists 304, 306, 308 are shown in other regions of the screen. These pick lists are associated with one of the fields 312 and are automatically displayed when a user selects a field. By using the system, the user is automatically presented with these pick lists to simplify the assessment generation, to create an electronic record, and to ensure the assessment is complete and important information is not inadvertently overlooked. There is also a screen area 310 that is provided for the user to make comments in addition to any information in the pick lists.

Each assessment screen has its own set of pick lists that aid in performing that particular assessment. Each field of an assessment screen may have its own set of nested pick lists. For example, as many as four levels of pick lists and sub pick lists may exist for a field. When a choice from a pick list is selected by the user, it is entered in the text box 314 that is to the right of the field.

Although not explicitly shown in the figures, each screen or portion of a screen can require an electronic signature before the patient's electronic medical record is updated. As is known in the art, asking for a user to enter a secret password and then pressing some type of “Sign Here” option is one typical method for electronically signing a document. If a document includes the need for a second signature, then a message can automatically be generated that is sent to selected users that informs them of the need for additional signatures on a document. Thus, although a document may be generated and even saved, or stored, in the system, it is not included in a patient's electronic medical record until it has been properly signed. Even though the document may be retrievable (as it needs to be for subsequent signatures) there is some indication provided that the document has not been properly signed. Additionally, as noted above, a second signature may be required from another user to verify or approve the document before it is officially included within the electronic medial record of the patient.

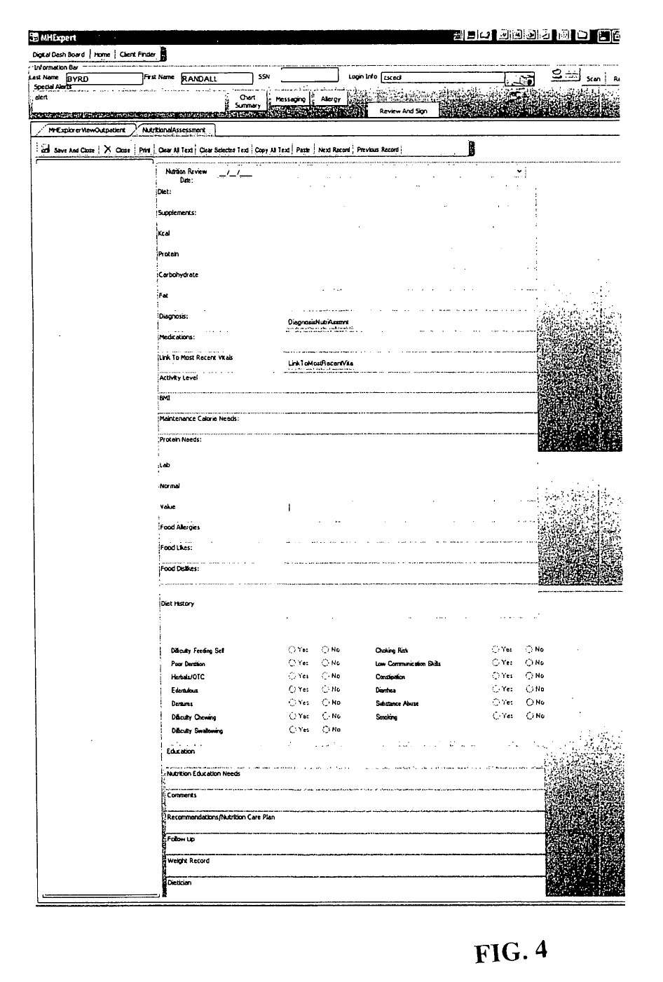

FIG. 4 depicts an exemplary Nutritional Assessment screen and is indicative of the type of information useful in such an assessment. As mentioned before, there are a number of different assessments included in the present system and performing them is greatly simplified using the pick lists and sub pick lists associated with each type of assessment.

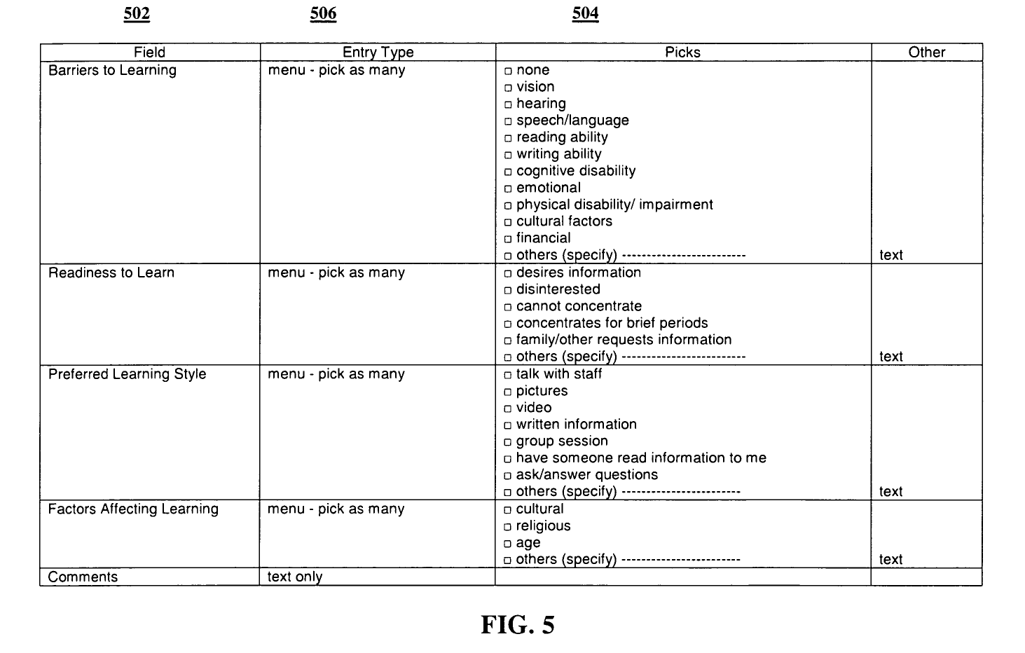

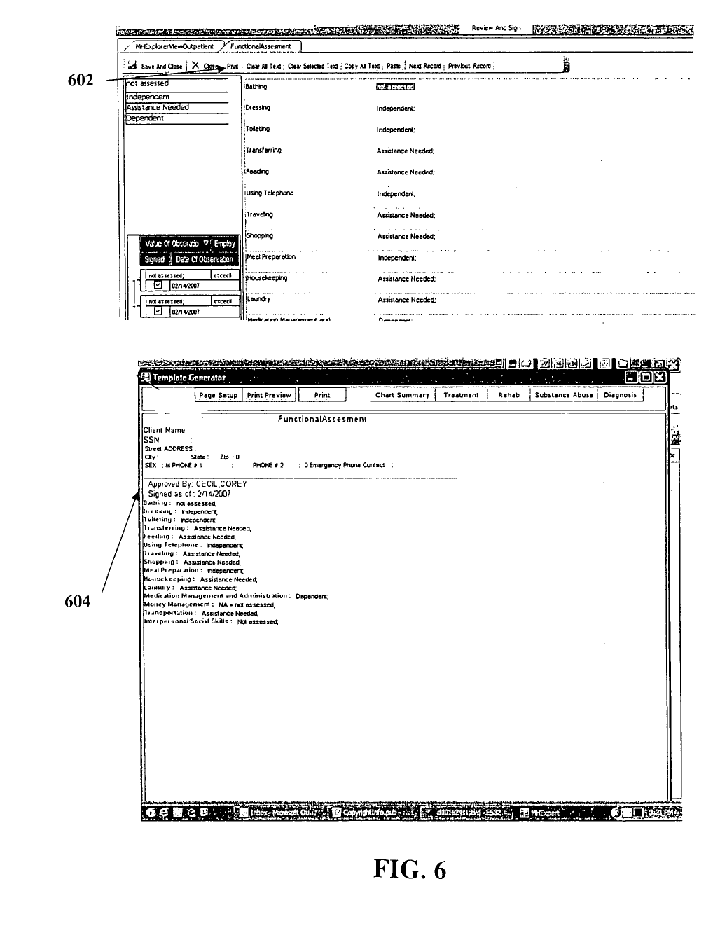

For example, FIG. 5 depicts the information of an educational assessment. When that assessment screen is provided to a user, the fields 502 will be displayed. As each field is selected by the user, the appropriate pick list 504 for that field will be displayed as well. The column 506 defines what type of pick list is shown. In this example, the pick lists are provided as menus from which the user can select as many items as appropriate. Once an assessment is complete a report can be generated and/or printed as shown in FIG. 6. The “Print” selection 602 can be selected to provide the report 604 as shown. Not only is information in the assessment provided but information about the assessment (e.g., approval, signatures, etc.) is provided as well.

The Patient Info

Patient information can be viewed and updated in a variety of ways. For examples, there are basic patient demographics that can be viewed and updated from one screen. Because the present system may be integrated with existing patient databases, this demographic information can be easily imported into the system without manually entering all such data. In addition to individual patient data (e.g., demographics, treatment team, contact info, etc.), patients may be logically assigned into different treatment groups. Thus, patients may be identified by their individual information as well as by there membership in a group.

Messaging System

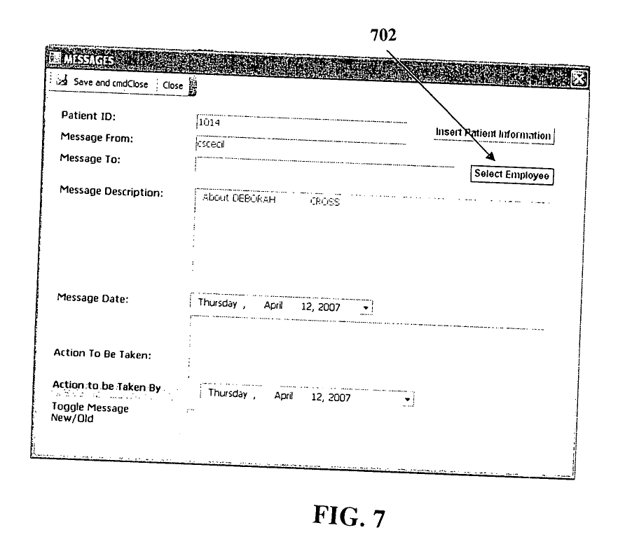

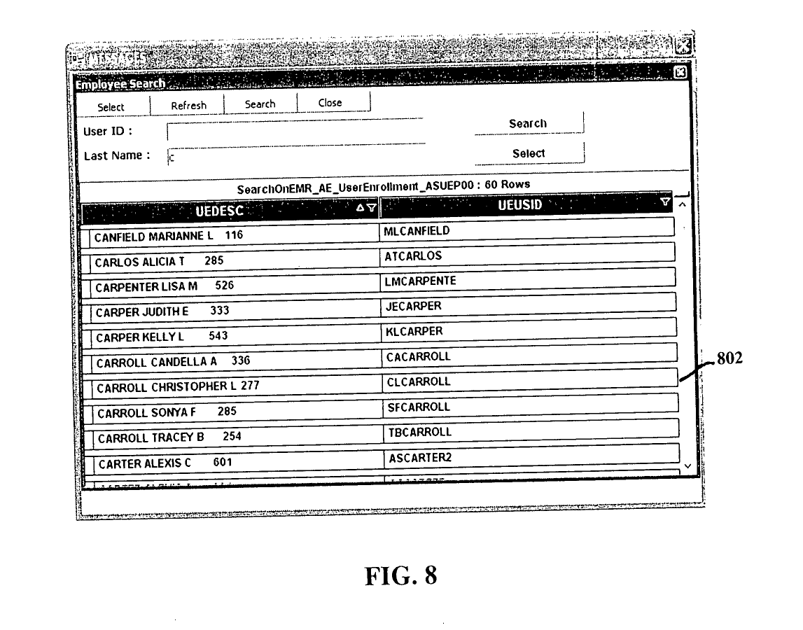

One beneficial aspect of the present system is the capability to send messages to any other user of the system. As mentioned briefly a “Messaging” button was available from the welcome screen shown in FIG. 1. By selecting this button, a user is presented a message screen as shown in FIG. 7. This message screen can, for example, be used to select another user whose signature is needed for a document's approval to be complete. The user would select the employee using interface button 702 in order to be presented the search screen of FIG. 8. Using the search capability of the system, the user would locate the appropriate employee or employees for the message and then be returned to the screen of FIG. 7 in order to complete the message. The exemplary message of FIG. 7 includes patient identification information, “To” and “From” fields, action dates, and the message window. Other information could be provided as well without departing from the scope of the present invention. When a user is logged in to the system, messages will be delivered to that user and can be viewed as needed. As is well known, messages may be replied to after being viewed and messages can be sent to groups of users as well.

Medical Monitoring

Some information such as blood pressure or blood glucose levels, for example, may have historical significance and a user may want to have this information saved and available for retrieval. Thus, the present system can include a way to input medical monitoring type data in such a way that historical trends may be identified and watched. Such items as height, weight, pulse, oxygen, etc may be monitored. Also, other useful information such as known allergies of the patient may be tracked by the system as well. A complete health history may also be generated and stored within the present system.

Diagnosis

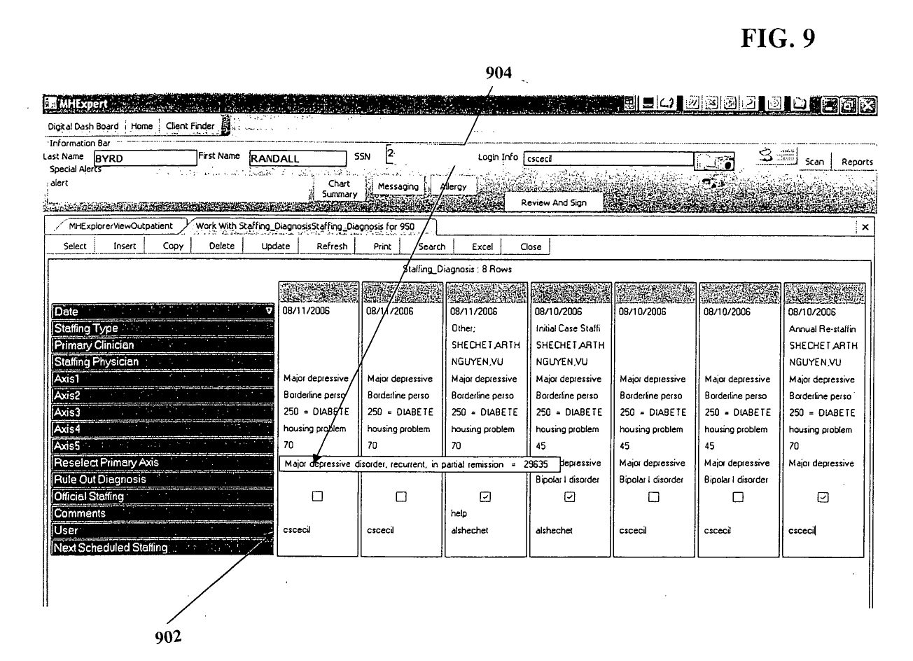

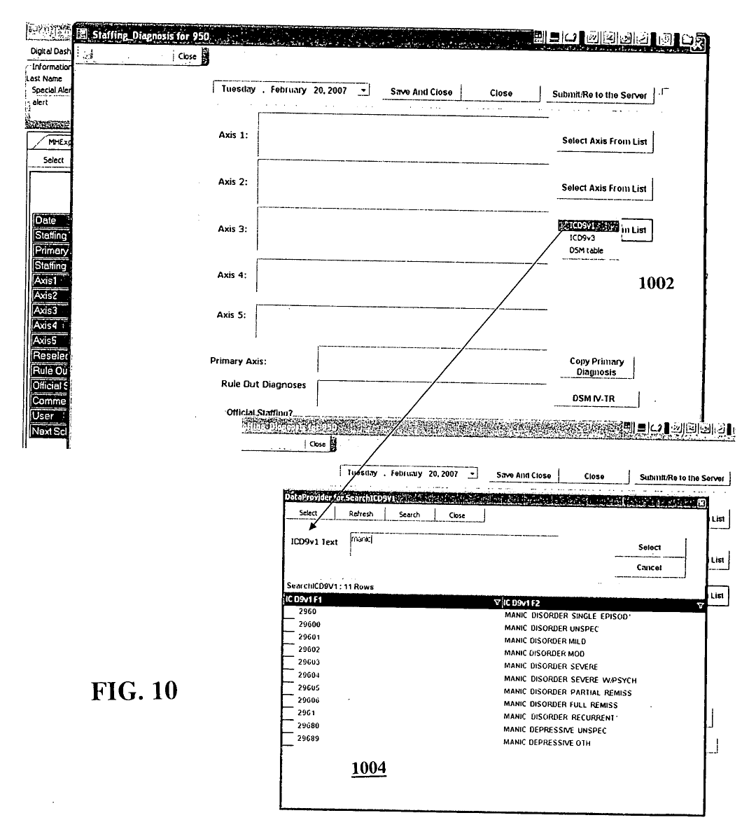

A Diagnosis log screen is shown in FIG. 9 that is opened based on a user's selection of that option from the screen of FIG. 1. As shown, each diagnosis 902 is briefly shown in a side-by-side arrangement. Other ways of presenting this information may be utilized as well without departing from the scope of the present invention. One useful feature is for a text area to 904 to expand on a mouse-over operation so that the diagnosis may be reviewed without actually opening the diagnosis. However, to update a diagnosis, a diagnosis is first selected and then the “Update” tab is selected. The “Insert” tab may be used to open a blank diagnosis entry form. Such a form is shown in FIG. 10.

As shown, a user can select from different table sources 902 to be presented with a table of choices 1004 to enter in the Axis n fields. These tables use the well known names and code numbers known in the behavioral healthcare environment. Axis 4 is typically selected from a pick list of possible problems (or entered manually) and Axis 5 is a GAF score that ranges from 1-100. A reminder screen of what the scores mean may be provided to a user as well.

Treatment Plans

The treatment plan of the present system is a dynamic and fluid document and therefore, date stamps and electronic signatures are a part of the system. For problems that are current, new objectives may be added at any time; current objectives may be achieved or discontinued; and target dates may need to be reset if not achieved by a previous target date. For each objective, current methods/interventions may be discontinued; new methods/interventions may be added; and the staff assigned to the method/intervention may be changed. The Plan usually begins with identifying all “problems to be addressed”. For each such problem at least one unique “goal” is identified to be met by a “target date”. The present system facilitates the creation, monitoring, and reporting of such a plan through the use of interface screens and other databases of information. For example, based on the problem identified (e.g., “depression”) a pick list of goals may be presented to the user for easy selection.

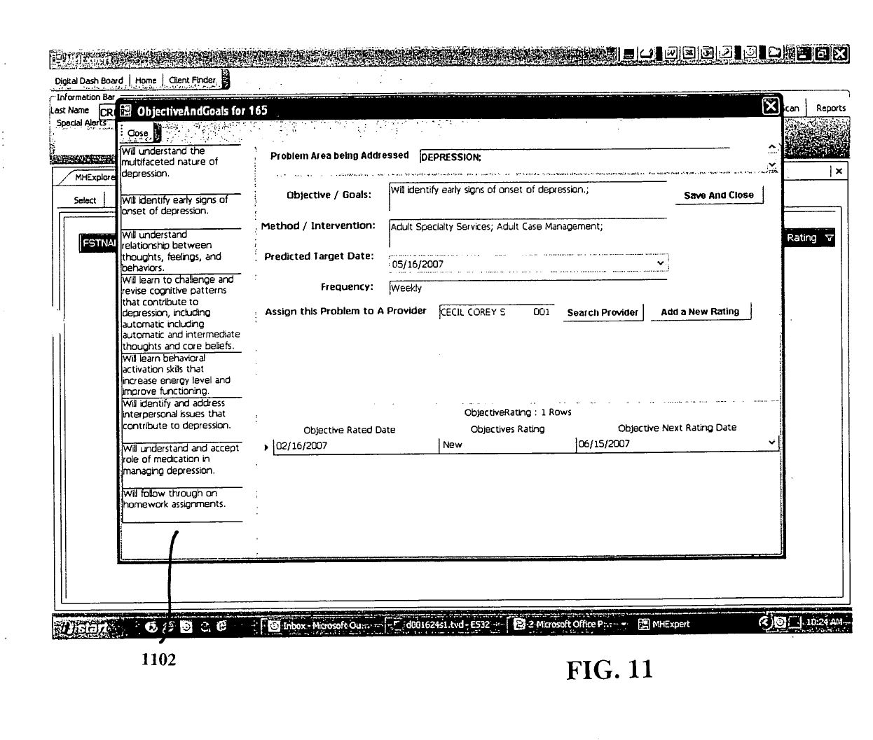

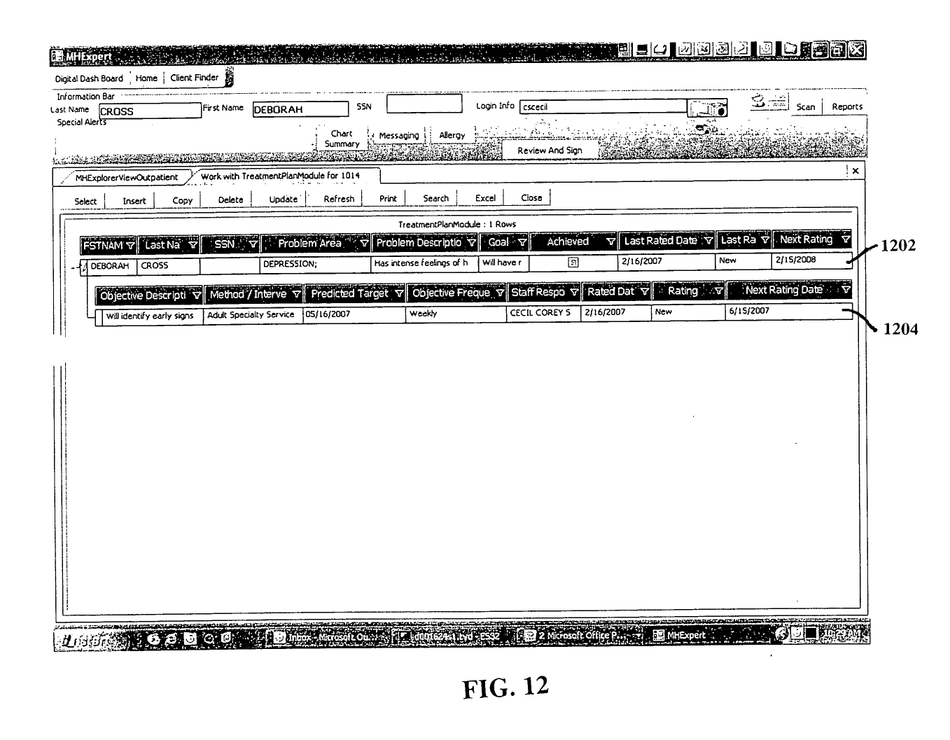

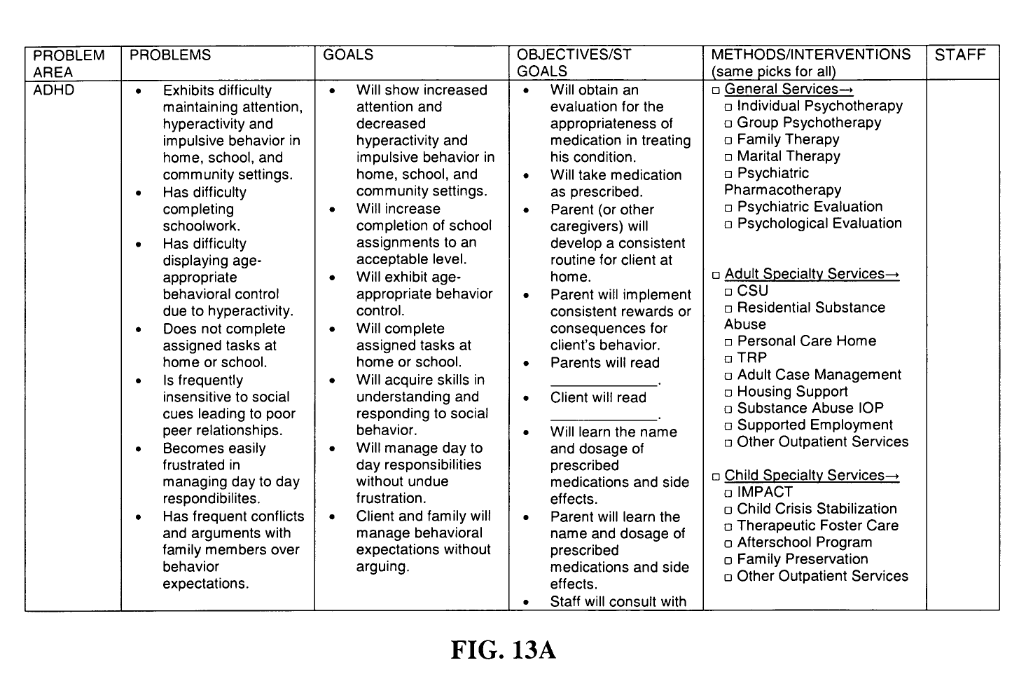

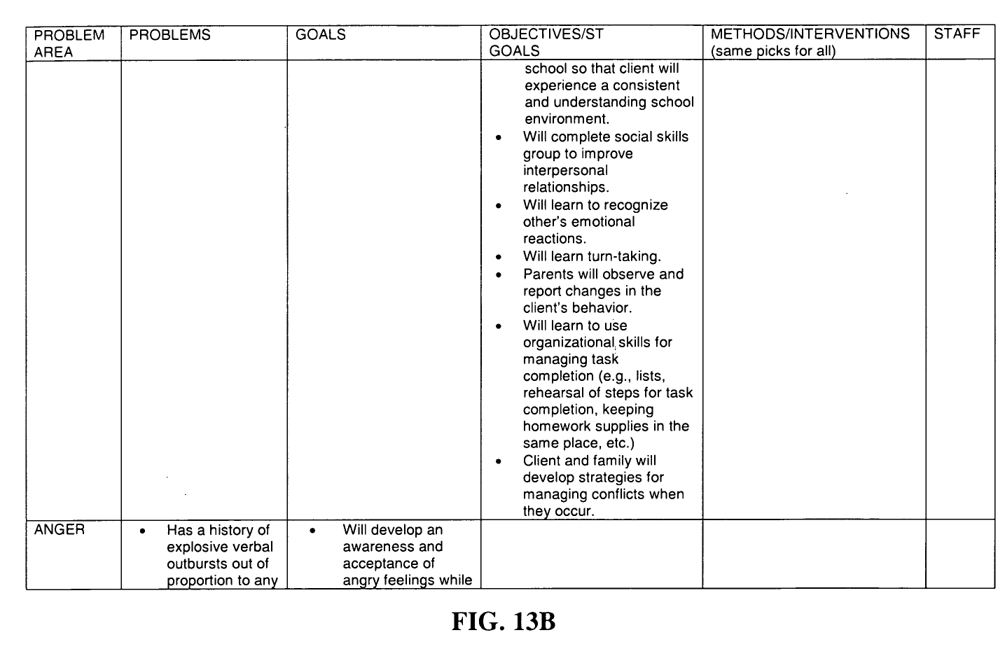

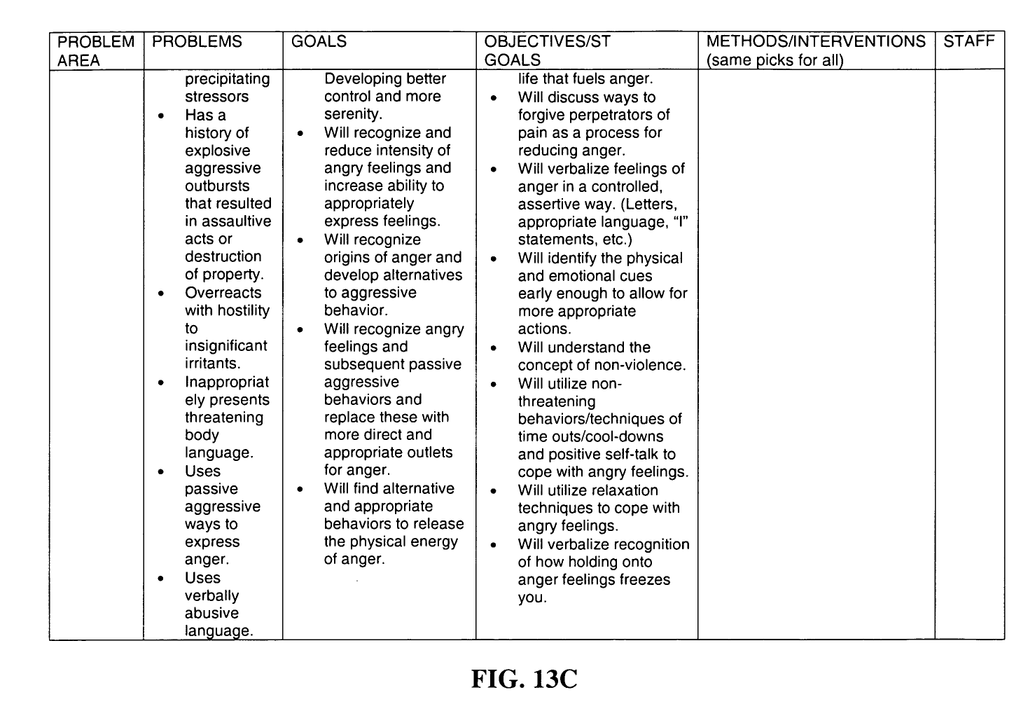

For example, FIG. 11 shows a screen that facilitates the entering of Goals and Objectives that correspond to a Problem. The pick list 1102 is shown to a user for simple selection of an Objective/Goal. The other information on the screen of FIG. 11 may be manually entered or itself come from an appropriate pick list. A summary screen is shown in FIG. 12. A plan 1202 is shown with a list of objectives 1204 underneath it. The user can select and view either the plan 1202 or an objective 1204. Although only one plan and objective is shown in FIG. 12, one of ordinary skill will recognize than a plurality of plans and objectives may be shown on the screen as well. FIGS. 13A-C depict a brief example of the type of information that may be included in a pick list system associated with a treatment plan. This information is exemplary and may, of course include, many, many more problems, objectives, goals, and methods.

To aid in creating the treatment plan, the assessment screens may include links to the treatment plan. For example, when conducting a Psychosocial Exam, a “Problems Addressed” button can be provided on that assessment screen that automatically opens a screen to add a “Problem” to the treatment plan. Similarly, the linking also occurs in reverse such that the “Problems Addressed” field in an assessment screen may be populated from the information in the treatment plan. Another beneficial aspect of the present invention is the robust reporting of the treatment plan that may be provided. Because the information is electronically stored with a variety of different fields, a custom report of almost any aspect of the treatment plan may be generated by selecting the criteria for reporting that a user feels is appropriate. For example, the status of all problems may be reported, just problems having a missed target date, just problems that have had their goals achieved or just problems that have had their goals discontinued. Thus, progress reports may be generated that show both successes and which risks remain. Accordingly, one of ordinary skill will recognize that the present system provides a wide variety of reporting option related to a treatment plan.

With the electronic storage of all the information and the robust report generating capabilities of the system, the work efforts of a user may be easily monitored and reviewed by a supervisor or mentor. With the proper authorization checks, a mentor can access the screens that were created by a particular user and then reviewed. By utilizing the messaging function, messages can be easily sent to the user with comments and suggestions. In a more formal way, this review and messaging capability may be utilized to satisfy any compliance mandates that may be imposed as well.

Pharmacy/Lab Interface

The system described herein may also include the capability to assist the user (if a physician) to write a prescription. Thus, from the same screen and computer that is being used to perform an assessment, or review a treatment plan, the user may select an interface screen that identifies medication and allows the user to generate the prescription. This information is automatically stored as part of the patient's electronic medical records. Similarly, screens may be presented to a user to order lab tests and to review lab results.

Billing

The present system includes the capability to define an “appointment” for a patient. The pending appointments are stored in an “appointment Table”. When a patient arrives at their appointment and the clinician performs services, a billing document is generated. The billing document is populated with as much information as possible from the different electronic data that was captured or created during the performance of the services and from the patient's history. The billing document can also include a progress note report that identifies how the objectives, goals and methods of the treatment plan are progressing.

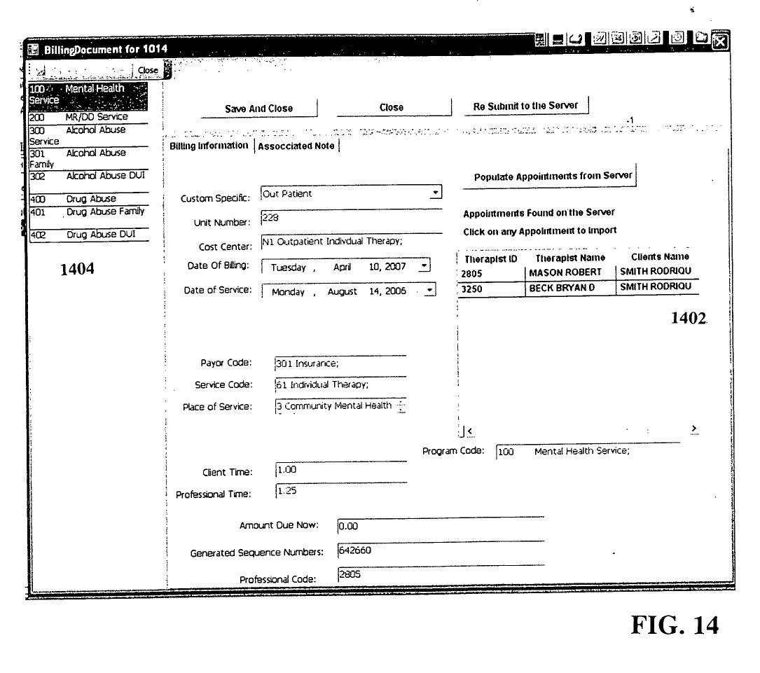

FIG. 14 depicts an exemplary billing document that includes useful information for performing the bill generation and collection functions. In particular to the present system, a list 1402 of current appointments is located from the system and presented to the user. Simple selection of an item from this list allows many of the fields to be populated in the billing document. Also, a pick list 1404 of program codes may be presented as well to make selection of this item easy and straightforward. The billing information from the system can be exported to other billing applications that may be external to the present system. In this way, the present system integrated within an environment of other enterprise applications.

A number of different authorization and releases are typically required when providing healthcare services to a patient. The present system includes provisions for presenting these documents electronically to a patient using the same system the user uses when performing assessments and other services. Thus, there are provisions to capture a signature of the patients in electronic form. One of ordinary skill will recognize that there are a variety of functionally equivalent methods to accomplish such a capture of a signature.

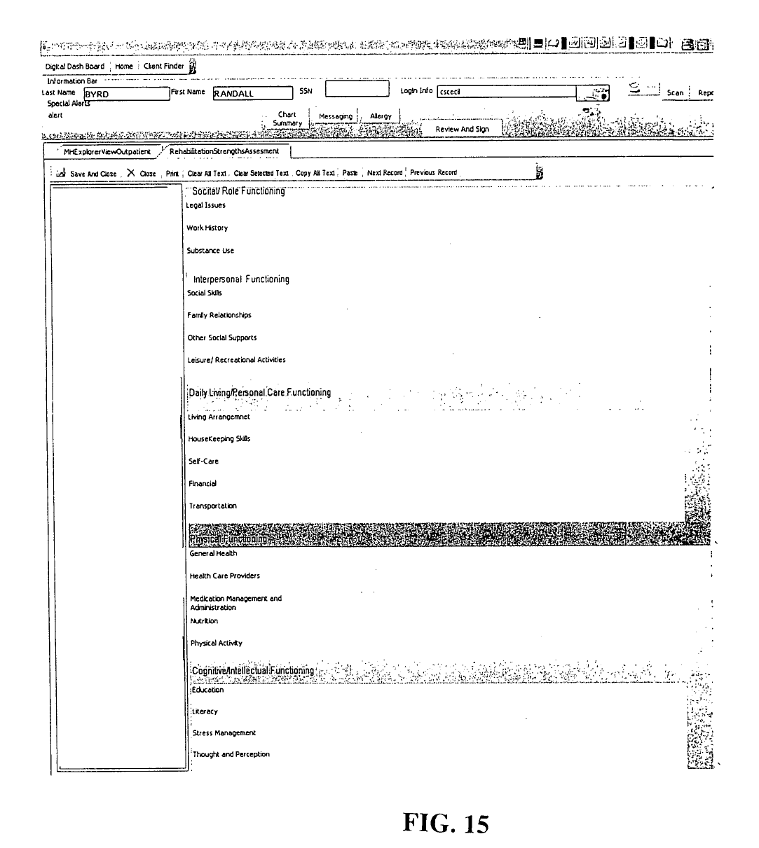

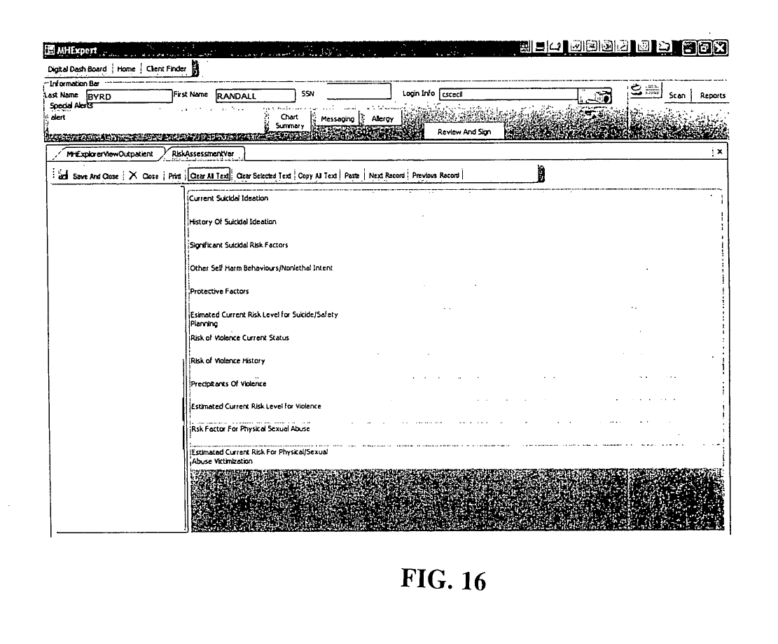

In operation, the users of the system may have desktop computer systems, laptops, or other mobile computing platforms that permit them to view the screens discussed above and provide input data for completing these screens. Such input can come from tablet based handwriting recognition, external databases, voice capture capability, and keyboarding. As a result, a system is provided that simplifies and automates documenting a behavioral healthcare environment. By providing interface screens that prompt the user throughout the creation of risk assessments and treatment pathways for vital information, the diagnosis and treatment plan for a patient are accurately and easily completed. For example, FIG. 15 shows a rehabilitations strengths assessment screen and FIG. 16 shows a risk assessment screen. By providing these screens to a user along with the underlying pick lists that allow information to be selected, the user is guided through the process using well accepted and well known successful strategies for diagnosing a patient and developing a treatment pathway.

As for the server or the client systems, no specific computer hardware and software platform are required. Both systems can be constructed from conventional computer equipment and software that provides the capacity, performance, security, scalability, and connectivity to accomplish the functionality described herein for potentially dozens of simultaneous users.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A software application that when executing on one or more processors performs the steps of:
presenting a first interface screen to a user for collecting assessment information about a patient related to behavioral healthcare;
presenting a second interface screen to the user for collecting diagnosis information about the patient related to behavioral healthcare;
presenting a third interface screen to the user for collecting treatment information about the patient related to behavioral healthcare; and
providing as output a report including at least some of the assessment information, the diagnosis information, and the treatment information.

2. The software application of claim 1, wherein the assessment information includes a substance abuse assessment.

3. The software application of claim 1, wherein the assessment information includes a physical health exam.

4. The software application of claim 1, wherein the assessment information includes a risk assessment for the patient.

5. The software application of claim 1, wherein the assessment information includes a rehabilitation assessment.

6. The software application of claim 1, further comprising:
presenting a pharmacy screen configured to allow generation of a prescription for the patient.

7. The software application of claim 1, further comprising:
presenting a lab screen configured to allow ordering lab services for the patient.

8. The software application of claim 1, wherein the first interface screen includes a plurality of fields, each field corresponding to data to be collected about the patient.

9. The software application of claim 8, wherein each field has associated with it a respective pick list which provides possible data for the user to enter in each field.

10. The software application of claim 9, wherein the pick list is a nested list having at least four levels.

11. The software application of claim 1, wherein a plurality of electronic documents are created based on some of the assessment information, diagnosis information, and treatment information.

12. The software application of claim 11, wherein each of the electronic documents require an electronic signature by the user before being included in an electronic medical history.

13. The software application of claim 12, wherein at least some of the documents additionally require verifying by another user before being included.

14. The software application of claim 1, further comprising:
presenting a messaging interface screen that permits the user to compose a message to be sent to other users.

15. The software application of claim 14, wherein the message is composed in response to a first user reviewing services performed by a second user in treating the patient.

16. The software application of claim 1, further comprising:
importing data from an existing patient database to identify demographic and other information about the patient.

17. The software application of claim 1, further comprising:
integrating with an external billing application.

18. The software application of claim 1, wherein the treatment information includes a treatment plan.

19. The software application of claim 18, wherein the treatment plan includes a plurality of objectives, goals and methods.

20. The software application of claim 19, wherein each of the objectives, goals and methods include a respective pick list of items the user can select when completing the treatment plan.

21. The software of claim 18, wherein the report includes a progress of the patient with respect to the treatment plan.

22. The software application of claim 1, wherein the third interface screen includes identification of a plurality of Axes.

23. The software application of claim 22, wherein a table of conditions presented to the user to provide a list of conditions to associate with each Axis.

24. The software application of claim 23, wherein the table is selected from on of ICD9v1, ICD9v3, and Diagnostic and Statistical Manual.

25. A system comprising:
a server executing a software application that performs the steps of:
presenting a first interface screen to a user for collecting assessment information about a patient related to behavioral healthcare;
presenting a second interface screen to the user for collecting diagnosis information about the patient related to behavioral healthcare;
presenting a third interface screen to the user for collecting treatment information about the patient related to behavioral healthcare; and
providing as output a report including at least some of the assessment information, the diagnosis information, and the treatment information;
a plurality of client systems in communication with the server, the first, second, and third interface screens being displayed at each client.

26. The system of claim 25, further comprising:
a computer-accessible storage device configured to store the assessment information, diagnosis information, and treatment information.

27. The system of claim 25, wherein at least one of the client systems includes voice capture capability for providing one of the assessment, diagnosis, and treatment information to the server.

28. The system of claim 25, wherein at least one of the client systems includes a writing capture capability for providing one of the assessment, diagnosis, and treatment information to the server.

29. The system of claim 25, wherein at least one of the client systems is a portable device.
